(19) United States
(12) Patent Application Publication
(10) Pub. No.: US 2014/0100683 A1
(43) Pub. Date: Apr. 10, 2014

(54) MULTIMEDIA MP3/MP4 PACE RESPONSIVE SENSORED FOOTWEAR

(71) Applicant: Bonnie Patricia White, Windsor (GB)

(72) Inventor: Bonnie Patricia White, Windsor (GB)

(21) Appl. No.: 14/116,282

(22) PCT Filed: Jun. 2, 2010
(86) PCT No.: PCT/GB2010/001084

§ 371 Date: Dec. 19, 2013

(51) Int. Cl. G06F 17/30

(52) U.S. Cl. CPC G06F 17/30749
USPC 700/94

(57) ABSTRACT

Footwear (10), that has (2) sensing means (20), on toe and heel end, under both left and right ground engaging body (14), when user is moving, as in jogging, will trigger automatic audio signal of transmitter (16) located in compartment (15) on upper (12) and compartment (25) in ground engaging body (14), or multimedia mp3, mp4, images in transmitter (16) upon constant weight transference between toe and heel end using both sensing means (20), and has a manual override (21-23), to end or begin audio signal (16) or multimedia images (16), in compartment (15 or 25), independently of both sensing means (20). Compartment (15 and 25), serve as a mounting means for audio signal of transmitter (16), and full multimedia capability with mp3, mp4 images. Footwear (10) is waterproof protected by pivoted cover member (18).

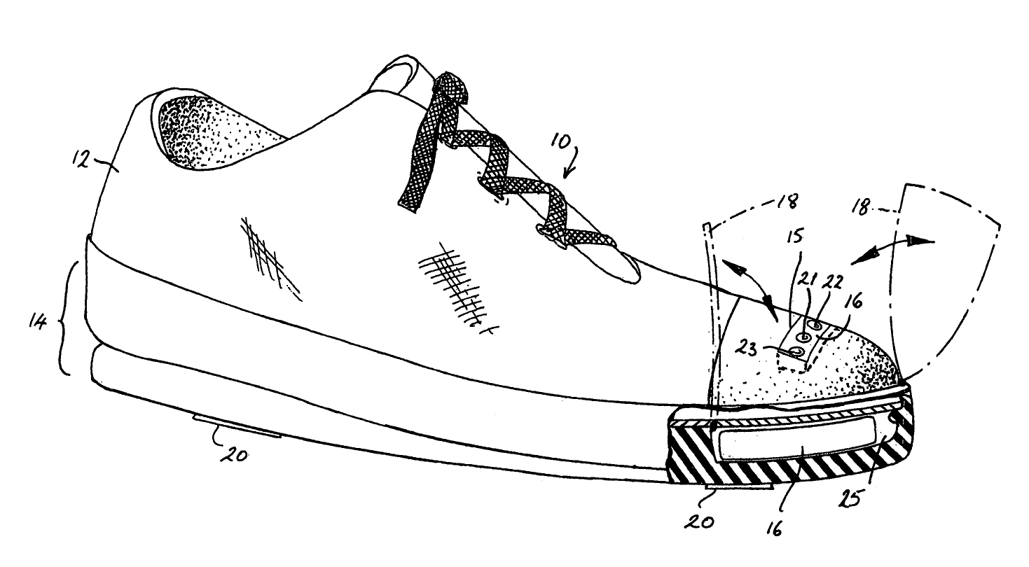

### TECHNICAL FIELD

This invention relates to articles of footwear.

### BACKGROUND

It is customary for people to be accompanied by music whilst they are engaged in exercise such as running, jogging, keep-fit routines in gymnasia, and the like. Although such musical accompaniment can be provided communally by loud speakers in the room where exercise is undertaken, more conveniently such musical accompaniment is provided by a personal sound playing device that is carried in a pocket or clipped on a belt or other garment of the person engaged in the exercise, a headphone or headset being connected by wiring to the device to convey either the sound wave or the sound signal to that person's ears.

With such arrangements, it is in general difficult to maintain the rhythm required for a particular exercise independently of the rhythm of the music being played by the device. For example a fast running or jogging rhythm is difficult to sustain whilst a slow waltz, say, is being played.

Furthermore, it often happens that the individual is so absorbed by the music being played that he/she slows down and even stops his/her engagement in the exercise routine.

It is therefore considered desirable to overcome or at least minimise the above-mentioned and/or other disadvantages of the prior art.

### SUMMARY OF THE INVENTION

Accordingly the present invention contemplates an article of footwear comprising a so-called upper and a ground engaging body,

wherein the upper or the body includes mounting means for a transmitter of an audio signal.

and wherein the ground engaging body incorporates sensing means responsive to the pace, i.e. to the footfall repetition rate, of the wearer of said article, said sensing means being operable on the transmitter and rendering it either EFFECTIVE—when the wearer is running or jogging or INEFFECTIVE—when the wearer is stationary or merely walking.

Preferably, the transmitter is rendered EFFECTIVE when the transmitter transmits a sensible signal, e.g. is switched to an ON condition, and is rendered INEFFECTIVE when said sensible signal is muted or not transmitted, e.g. equivalent to being switched to an OFF condition.

The wearer can thus be encouraged to continue in his her running or jogging or other exercise regime in order to continue properly to receive the generated audio signal.

Preferably the sensing means includes at least one sensing pad mounted externally on or incorporated in the lowermost sole of the ground engaging body of the article of footwear. In an exemplary embodiment two such sensing pads may be provided on each of a pair of footwear articles, the sensing pads of each of the right and left article being located respectively forwardly and rearwardly of that article.

Advantageously, the ground engaging body of the article of footwear comprises a cavity with a side opening—optionally closable by a sliding or a pivoted cover member—to receive therein said audio signal transmitter.

Alternatively the said upper of the article of footwear is provided with a compartment—optionally closable by a sliding or a pivoted cover member—into which said audio signal transmitter can be inserted.

In either case the cover may be a snap-shut construction and/or may include a waterproof seal. The cover member may be provided on an inward face with a resilient member, e.g. a foam pad, in use to stabilise the transmitter within the cavity or compartment

Preferably, said cavity or compartment is fitted with an electrical connector element (e.g. a USB connector socket) to be engaged by a corresponding electrical connector element (e.g. a USB connector plug) provided on, e.g. projecting from, said audio signal transmitter.

Advantageously said audio signal transmitter comprises an MP3 player or an MP4 player that can transmit both an audio signal and a video signal, For either the MP3 player or the MP4 player, switch means may be provided in association with the article of footwear to bypass the sensing means and to permit transmission respectively of the audio signal of the MP3 player or of both audio and video signals of the MP4 player when the footwear wearer is at rest.

Preferably said audio signal transmitter is operative to transmit said signal wirelessly, e.g. using a Bluetooth radio communications protocol. Alternatively said audio signal transmitter is operative to transmit said signal by infra-red.

Controls for the said transmitter may be provided on the article of footwear and/or on a remote device. The remote device may be an earpiece, headphone or headset, or a bracelet that is to be worn on the wrist of the user. Said controls may include the aforesaid switch means to bypass the sensing means and permit operation of the audio signal transmitter (with or without a video signal) even if the footwear article is at rest.

### BRIEF DESCRIPTION OF THE DRAWINGS

By way of example embodiments of this invention will now be described with reference to the accompanying drawing which is a partly cross-sectional schematic perspective view of differing forms of a footwear article embodying the invention.

### DETAILED DESCRIPTION OF EXAMPLE(S) OF THE INVENTION

The illustrated article of footwear 10 is a so-called “trainer” comprising an upper 12 and a ground engaging body 14. Either the upper 12 or the body 14 includes a compartment 15 or 25 serving as mounting means for a transmitter 16 of an audio signal.

In use, the audio signal transmitter 16 is inserted into the compartment 15 or 25 which is closable either by a sliding cover member or, as shown, by a pivoted cover member 18 to provide water protection. As illustrated the cover member 18 for compartment 15 can have its pivot axis positioned forwardly or rearwardly of the compartment 15. The compartment 15 is fitted with an electrical connector element (e.g. a USB connector socket) to be engaged by a corresponding electrical connector element (e.g. a USB connector plug) provided on and projecting from the audio signal transmitter 16. The transmitter 16 preferably comprises an MP3 player operative to transmit the audio signal wirelessly, e.g. using a Bluetooth radio communications protocol.

The ground engaging body 14 of the trainer 10 incorporates sensing means 20 responsive to the pace, i.e. to the footfall repetition rate, of the wearer of said article. Said sensing means 20 is operable on the transmitter 16 rendering it either EFFECTIVE—when the wearer is running or jogging—or INEFFECTIVE—when the wearer is stationary or merely walking. When EFFECTIVE the transmitter 16 is switched to an ON condition in which it transmits a sensible signal. When the transmitter is rendered INEFFECTIVE—and equivalent to being switched to an OFF condition—in which said sensible signal is muted or not transmitted

In this illustrated embodiment the sensing means 20 includes at least one sensing pad (e.g. pressure responsive pad) mounted externally on the bottom of the ground engaging body 14. Alternatively the at least one sensing pad may be incorporated within the lowermost sole of the footwear article 10, and respond to the pressure thereon transmitted through part of the sole therebeneath. In embodiments (not shown) two pressure responsive pads may be provided as an electrically co-operative pair, one pad being at or adjacent the toe end of the article and the other paid being at or adjacent the heel end of the article. Conveniently such a pair of pads may be provided on each of a LEFT and a RIGHT article of footwear of a pair of such articles. The electrical co-operation may be such as to ensure the transmitter is INEFFECTIVE when the load on both the toe end pad and heel end pad are substantially equal to one another. Such an arrangement ensures cessation of the audio signal when the wearer ceases running or like motion.

Controls for said transmitter may be provided on the article of footwear as shown as buttons 21, 22 and 23 to provide an ON/OFF function, a recording-track changing function, an audio volume control function and, optionally, an eject function for the MP3 player to eject it from compartment 15 or 25. Alternatively or additionally corresponding controls can be provided on a remote device, e.g. on an earpiece, headphone or headset, or on a bracelet or wrist-band to be worn on the wrist of the user.

In another embodiment of this invention the compartment 15 provided in the upper 12 and that receives the MP3 player 16 is replaced by a cavity 25 in the ground engaging body 14 of the article of footwear 10, this cavity being provided with a side opening to receive therein the audio signal transmitter 16 and permit it to be accessed laterally. Alternatively both compartment 15 and cavity 25 are utilised.

In a modification, the MP3 player may be associated with visual signal means, e.g. LED's, to signal low battery charge. Alternatively or additionally it may be associated with a radio. Also alternatively or additionally, it may be associated with a media download facility and/or a built-in voice recording microphone (e.g. for use as a ‘karaoke’ device).

In still another embodiment the audio signal transmitter 16 may be associated with a speaker and apertures in the trainer's upper 12 or the ground engaging body 14 to provide for direct audio signal transmission.

In another modification the audio signal transmitter 16 comprises an MP4 player that can transmit both an audio signal and a video signal. In this case, an ON/OFF switch may be provided to cancel or to bypass any signal from the pace responsive sensing means such as to permit transmission of both audio and video signals even when the wearer is at rest.

In yet another embodiment, the controls 21-23 are provided in compartment 15 and are connected internally of the trainer 10 to the transmitter 16 which is housed in cavity 25. Signal transmission may be by infra-red or wireless, e.g. using the Bluetooth protocol. Alternatively the signal transmission may be a different ‘wifi’ protocol.

It will be appreciated that the ground engaging body 14 may be provided with one or more further cavities or compartments to retain one or more of a battery, an on-board charging unit (for the battery (if re-chargeable), and a removable memory card or flash card. A fixed expandable memory device may also be provided.

It will be noted that with any of the above-described embodiments and modifications of this invention the wearer can be encouraged to continue in his/her running or jogging or other exercise regime in order to continue to receive the audio signal generated by transmitter 16.

Other modifications and embodiments of the invention, which will be readily apparent to those skilled in this art, are to be deemed within the ambit and scope of the invention, and the particular embodiment(s) hereinbefore described may be varied in construction and detail, e.g. interchanging (where appropriate or desired) different features of each, without departing from the scope of the patent monopoly hereby sought.

1. An article of footwear comprising a so-called upper and a ground engaging body,
wherein either the upper or the body includes mounting means for a transmitter of an audio signal,
and wherein the ground engaging body incorporates sensing means responsive to the pace, i.e. to the footfall repetition rate, of the wearer of said article, said sensing means being operable on the transmitter to render it either EFFECTIVE when the wearer is running or jogging, and INEFFECTIVE when the wearer is stationary or merely walking.

2. An article of footwear according to claim 1, wherein the transmitter is rendered EFFECTIVE when the transmitter transmits a sensible signal, e.g. is switched to an ON condition, and is rendered INEFFECTIVE when said sensible signal is muted or not transmitted, e.g. is, or is equivalent to being, switched to an OFF condition.

3. An article of footwear according to claim 1 or claim 2 and further comprising switch means to provide an optional bypass to the sensing means and to permit operation of the signal transmitter even if the wearer is at rest.

4. An article of footwear according to claim 1, wherein the sensing means includes at least one sensing pad mounted externally on, or incorporated in, the lowermost sole of the ground engaging body of the article of footwear.

5. An article of footwear according to claim 4, wherein two said sensing pads are provided and located respectively forwardly and rearwardly of the article.

6. An article of footwear according to claim 1, wherein the ground engaging body of the article of footwear comprises a cavity with a side opening to receive therein said audio signal transmitter.

7. An article of footwear according to claim 6 wherein said side opening is closable by a sliding or a pivoted cover member.

8. An article of footwear according to claim 7, wherein the cover member is provided on an inward face with a resilient member in use to stabilise the transmitter within the cavity when the cover member is closed.

9. An article of footwear according to claim 8, wherein the resilient member is a foam pad.

10. An article of footwear according to claim 6, wherein said cavity is fitted with an electrical connector element to be engaged by a corresponding electrical connector element provided on said audio signal transmitter.

11. An article of footwear according to claim 1, or claim 2 or claim 3 wherein the said upper of the article of footwear is provided with a compartment into which said audio signal transmitter can be inserted.

12. An article of footwear according to claim 11, wherein the said compartment is closable by a sliding or a pivoted cover member.

13. An article of footwear according to claim 11, wherein the cover member is provided on an inward face with a resilient member in use to stabilise the transmitter within the compartment when the cover member is closed.

14. An article of footwear according to claim 13, wherein the resilient member is a foam pad.

15. An article of footwear according to claim 11, wherein said compartment is fitted with an electrical connector element to be engaged by a corresponding electrical connector element provided on said audio signal transmitter.

16. An article of footwear according to claim 10 or claim 15 wherein the first-mentioned electrical connector element is a USB connector and is to be engaged by a USB connector plug projecting from said audio signal transmitter.

17. An article of footwear according to any one of claims 1, 2, or 4 to 10 wherein said audio signal transmitter comprises an MP3 player.

18. An article of footwear according to any one of claims 1, 2, or 4 to 10 wherein said audio signal transmitter comprises an MP4 player that can transmit both an audio signal and a video signal.

19. An article of footwear according to claim 18, wherein when said switch means is operable to provide a bypass for the sensing means such that the MP4 player can transmit both audio and video signals even when the wearer is at rest.

20. An article of footwear according to any one of claims 1, 2, or 4 to 10, wherein said audio signal transmitter is operative to transmit said signal wirelessly.

21. An article of footwear according to any one of claims 1, 2, or 4 to 10, wherein said audio signal transmitter is operative to transmit said signal using a Bluetooth radio communications protocol.

22. An article of footwear according to any one of claims 1, 2, or 4 to 10, wherein said audio signal transmitter is operative to transmit said signal by infra-red transmission.

23. An article of footwear according to any one of claims 1, 2, or 4 to 10 wherein controls for said transmitter are provided on the article of footwear.

24. An article of footwear according to any one of claims 1, 2, or 4 to 10, wherein controls for said transmitter are provided on a remote device.

25. An article of footwear according to claim 24 wherein said remote device comprises an earpiece, headphone or headset, or a bracelet that is to be worn on the wrist of the user.

26. (canceled)
